(19) United States
(12) Patent Application Publication
(10) Pub. No.: US 2006/0125613 A1
(43) Pub. Date: Jun. 15, 2006

(54) Tire pressure detector and alarm system

(76) Inventor: Yueh-Ying Ko, Banciao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/002,301

(22) Filed: Dec. 3, 2004

(51) Int. Cl. B60C 23/00

(52) U.S. Cl. 340/447

(57) ABSTRACT

A tire pressure detector and alarm system is disclosed to include a battery-operated tire pressure detector installed in the air valve of a vehicle wheel and controlled by a control switch formed of a metal probe and a diaphragm held metal conductor member for providing a radio alarm signal when tire pressure low, a locking device installed in the air valve of the vehicle wheel to lock the tire pressure detector to the air valve, and a receiver and alarm unit directly connectable to the socket for cigarette lighter for receiving radio alarm signal from the tire pressure detector and display the signal.

### BACKGROUND OF THE INVENTION

1. Field of the Invention

The present invention relates to apparatus to detect the air pressure of a vehicle wheel.

2. Description of the Related Art

The pressure of a vehicle wheel will leak gradually after a certain period in use, or when the temperature drops at night after radiation by sunlight. It is dangerous to drive the car if the tire pressure dropped below 28 psi. Insufficient tire pressure may cause the vehicle wheel to explore during a high speed running.

Various tire pressure detector and alarm devices have been disclosed and have appeared on the market. Exemplars are seen in Taiwan Publication Nos. 536489; 400811; 149143; 177543; 560445; 574077; 090946; 100539; 396794. These devices may use an electronic tire pressure detector or a mechanical tire pressure detector to detect the tire pressure. An electronic tire pressure detector uses a pressure sensor IC to detect tire pressure. However, an electronic tire pressure detector consumes much electric energy and is relatively less reliable.

A mechanical tire pressure detector must be installed in the rim or air valve of the vehicle wheel. FIGS. 1 and 2 show a mechanical tire pressure detector used with a radio receiver 18 according to the prior art. According to this design, the tire pressure detector comprises a casing 10, a movable metal contact plate 11, a metal spring member 12, a battery cell 13, and a radio transmitter 14. The casing 10 has a front neck 15 threaded onto the air valve 16. The movable metal contact plate 11 is kept in balance when the pressure of the vehicle wheel is normal. When the pressure of the vehicle wheel dropped below the normal range, the metal spring member 12 pushes the movable metal contact plate 11 upwards into contact with contacts 17 to close the circuit, thereby causing the radio transmitter 14 to send a radio alarm signal to the radio receiver 18 in the motor vehicle.

The aforesaid tire pressure detector and radio receiver system still has numerous drawbacks as outlined hereinafter:

1. The radio receiver 18 is arranged in a box. After mounting of the radio receiver in the motor vehicle, a power circuit must be installed to electrically connect the radio receiver to the battery power supply circuit of the motor vehicle. The installation of the radio receiver destroys the sense of beauty of the motor vehicle (see FIG. 1).

2. Because the front neck 15 of the casing 10 is directly threaded onto the air valve 16, a thief can remove the tire pressure detector from the air valve easily without any tool. Further, the tire pressure detector may be loosened easily upon vibration of the motor vehicle.

3. When removed the tire pressure detector from the air valve for inflating the vehicle wheel or receiving a repair work, the metal spring member 12 immediately pushes the movable metal contact plate 11 upwards into contact with contacts 17 to close the circuit, thereby wasting much electric energy.

4. The movable metal contact plate 11 tends to be forced upwards into contact with contacts 17 accidentally during vibration of the motor vehicle, thereby producing a false alarm signal.

### SUMMARY OF THE INVENTION

The present invention has been accomplished under the circumstances in view. It is the main object of the present invention to provide a tire pressure detector and alarm system, which has the receiver and alarm unit designed connectable to the socket for cigarette lighter to obtain the necessary working voltage from the car battery power supply. It is another object of the present invention to provide a tire pressure detector and alarm system, which positively locks the tire pressure detector to the air valve of the vehicle wheel, presenting disconnection of the tire pressure detector from the air valve by an external force. It is still another object of the present invention to provide a tire pressure detector and alarm system, which automatically cuts off the circuit to save power consumption when disconnected from the air valve of the vehicle wheel. It is still another object of the present invention to provide a tire pressure detector and alarm system, which is highly reliable and durable. To achieve these and other objects of the present invention, the tire pressure detector and alarm system comprises a battery-operated tire pressure detector installed in the air valve of a vehicle wheel and controlled by a control switch formed of a metal probe and a diaphragm held metal conductor member for providing a radio alarm signal when tire pressure low, a locking device installed in the air valve of the vehicle wheel to lock the tire pressure detector to the air valve, and a receiver and alarm unit directly connectable to the socket for cigarette lighter for receiving radio alarm signal from the tire pressure detector and display the signal.

### BRIEF DESCRIPTION OF THE DRAWINGS

FIG. 1 is a schematic drawing showing a tire pressure detector installed in a car according to the prior art.

FIG. 2 is a sectional view of a tie pressure detector according to the prior art.

FIG. 3 is a perspective view of a receiver and alarm unit for a tire pressure detector and alarm system according to the present invention.

FIG. 4 is a perspective view of a tire pressure detector for a tire pressure detector and alarm system according to the present invention.

FIG. 5 is an exploded view of the tire pressure detector according to the present invention.

FIG. 6 is a schematic sectional view of the tire pressure detector according to the present invention before connection to the air valve.

FIG. 7 is schematic sectional view of the present invention, showing the tire pressure detector installed in the air valve.

FIG. 8 is similar to FIG. 7 but showing the tire pressure detector in action upon tire pressure low.

FIG. 9 is a circuit diagram of the control IC board according to the present invention.

FIG. 10A is a circuit diagram of the receiver circuit according to the present invention.

FIG. 10B is a circuit diagram of the alarm circuit according to the present invention.

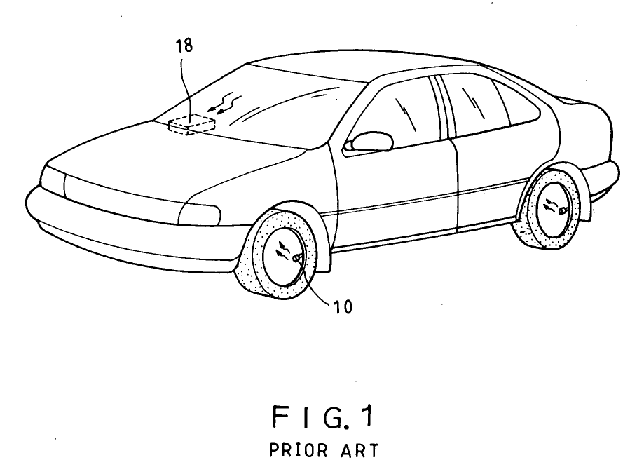

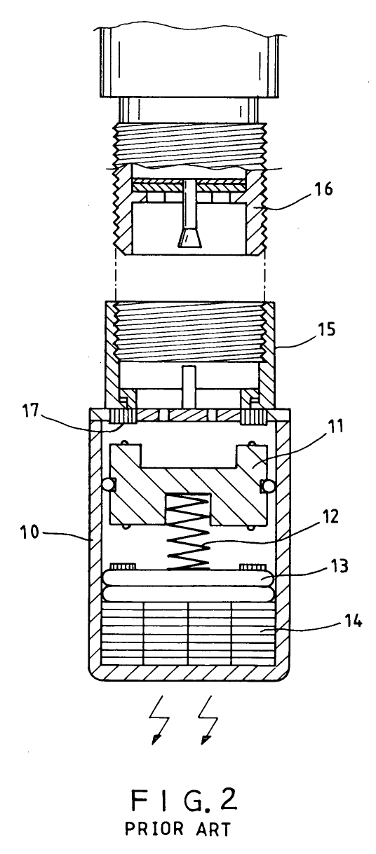

### DETAILED DESCRIPTION OF THE PREFERRED EMBODIMENTS

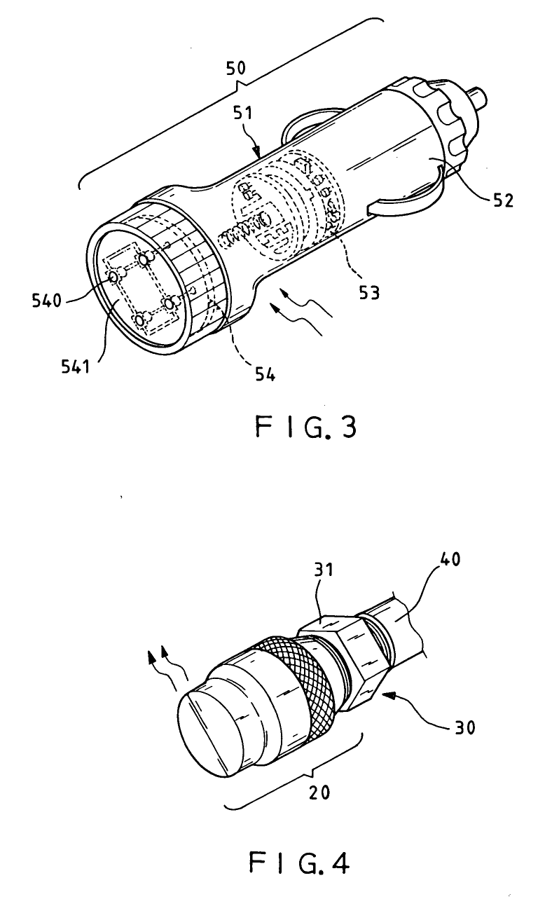

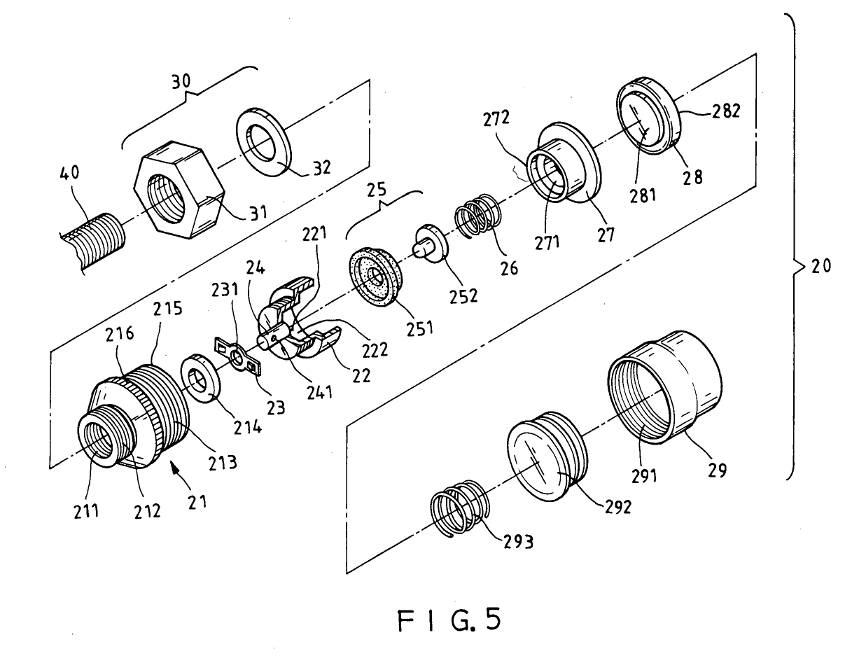

Referring to FIGS. 3 and 4, a tire pressure detector and alarm system in accordance with the present invention is shown comprising a tire pressure detector 20 installed in a vehicle wheel's air valve 40, a locking device 30, and a receiver and alarm unit 50 installed in the socket for electric lighter of the vehicle.

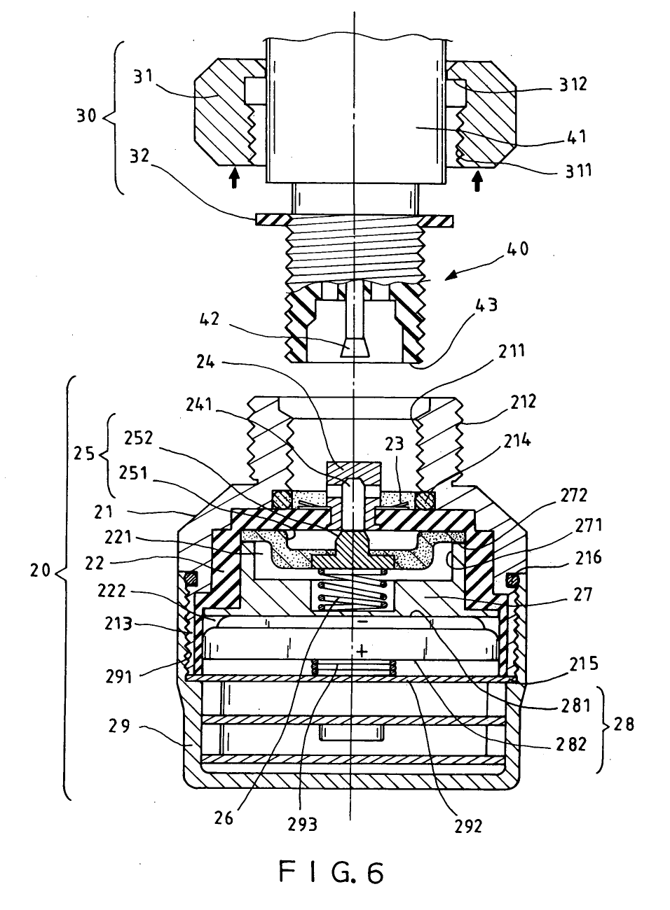

Referring to FIGS. 5˜7, the tire pressure detector 20 comprises:

a first metal casing 21, which comprises a front neck 211 connectable to the air valve 40, a first outer thread 212 extending around the periphery of the front neck 211, a second outer thread 213 extending around of the periphery of the body thereof, a first O-ring 214 mounted inside the front neck 211, and a second O-ring 216 fastened to the second outer thread 213;

an electrically insulative cap 22 mounted inside the first metal casing 21 and defining therein a first receiving chamber 221 and a second receiving chamber 222;

a metal probe 24 axially forwardly extending from the center of the front side of the electrically insulative cap 22 and having an air through hole 241 extending from the periphery to the bottom end thereof in air communication with the first receiving chamber 221;

a metal spring plate 23 mounted on the metal probe 24 inside the first metal casing 21 and stopped between the first O-ring 214 and the electrically insulative cap 22, having a center through hole 231 for the passing of the metal probe 24;

a flexible air pressure chamber 25 formed of an electrically insulative flexible diaphragm 251, which is inserted into the first receiving chamber 221 of the electrically insulative cap 22, and a metal conductor member 252, which is mounted in the electrically insulative flexible diaphragm 251 and stopped at the bottom end of the metal probe 24;

a negative pole metal spring member 26 provided at the bottom side of the metal conductor member 252;

a metal holder member 27 mounted in the first receiving chamber 221 of the electrically insulative cap 22 and having a front receptacle 271, which accommodates the negative pole metal spring member 26 and has a front edge 272 pressed on the periphery of the electrically insulative flexible diaphragm 251 to keep the first receiving chamber 221 of the electrically insulative cap 22 in an airtight status;

a battery cell (Li-ion battery) 28 mounted in the second receiving chamber 222 of the electrically insulative cap 22 with the positive terminal 281 maintained in contact with the metal holder member 27;

a second metal casing 29, which has an inner thread 291 threaded onto the second outer thread 213 of the first metal casing 21;

a control IC board 292 mounted inside the second metal casing 29 and kept in contact with the bottom edge 215 of the first metal casing 21; and

a positive pole metal spring member 293 installed in the control IC board 292 and stopped against the negative terminal 282 of the battery cell 28.

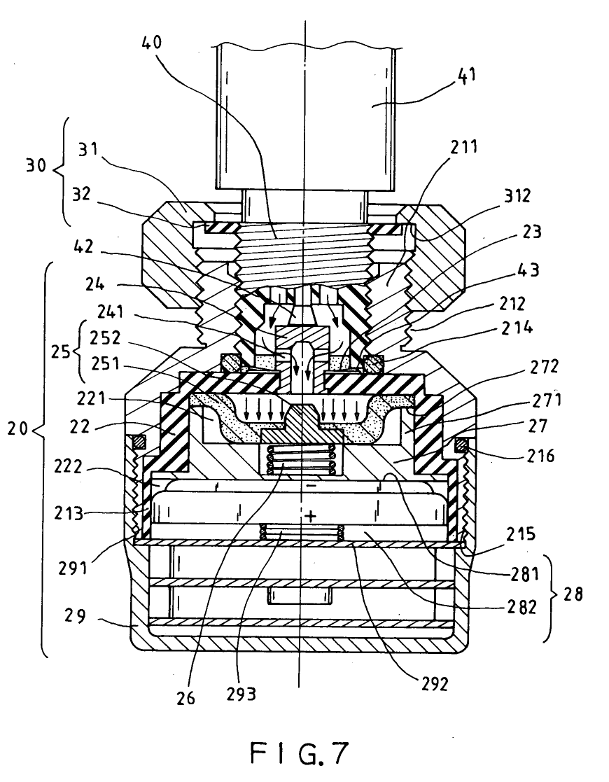

The locking device 30 comprises a locknut 31 and a packing plate 32. As shown in FIG. 6, the locknut 31 is mounted on the base 41 of the air valve 40, having an inner thread 311 threaded onto the first outer thread 212 of the first metal casing 21 and a top shoulder 312 above the inner thread 311. The packing plate 32 is threaded onto the air valve 40 and mounted inside the locknut 31 and stopped between the inner thread 311 and the top shoulder 312.

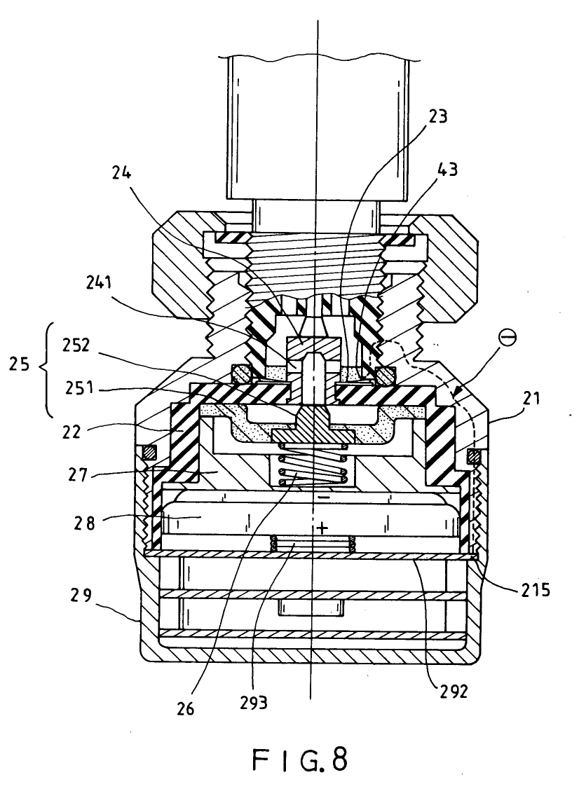

After connection of the front neck 211 of the first metal casing 21 to the air valve 40, the locknut 31 is threaded onto the first outer thread 212 to lock the tie pressure detector 20 to the air valve 40 (see FIG. 7). At this time, the bottom edge 43 of the air valve 40 is stopped at the first O-ring 214 and pressed against the metal spring plate 23.

After locking of the tire pressure detector 20, the metal probe 24 is pressed on the center control valve rod 42 of the air valve 40 to let air pass from the inside of the tire through the air through hole 241 into the flexible air pressure chamber 25 in the first receiving chamber 221, causing the electrically insulative flexible diaphragm 251 to displace downwards and to disconnect the metal conductor member 252 from the metal probe 24. This status means the tire pressure is within the normal range. Because the flexible diaphragm 251 is electrically insulative, the battery cell 28 is off at this time, and the control IC board 292 does no work and gives no signal. According to this embodiment, the electrically insulative flexible diaphragm 251 is made of rubber for the advantages of high sensitivity and durability. Further, the electrically insulative flexible diaphragm 251 holds the metal conductor member 252 in place to form the desired flexible air pressure chamber 25 that is easy to install.

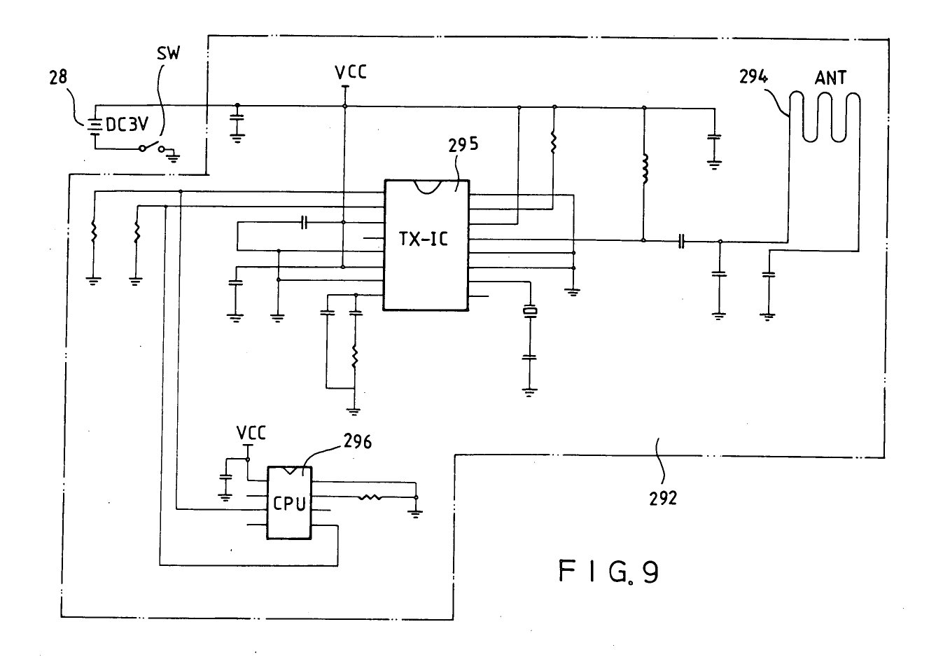

Referring to FIG. 8, when the air pressure of the tire dropped below the normal range, the negative pole metal spring member 26 pushes the flexible air pressure chamber 25 upwards to force the metal conductor member 252 into contact with the metal probe 24 and to further force the metal spring plate 23 into contact with the air valve 40, and therefore the negative terminal 281 of the battery cell 28 is electrically connected through the negative pole metal spring member 26, the metal conductor member 252, the metal probe 24, the metal spring plate 23, the air valve 40, the first metal casing 21, the second metal casing 29 and the negative terminal of the control IC board 292 to the positive terminal of the control IC board 292 and then the positive terminal 282 of the battery cell 28 via the positive pole metal spring member 293, and therefore the control IC board 292 is turned on to send a alarm signal to the receiver and alarm unit 50 by radio.

Referring to FIG. 3, the receiver and alarm unit 50 comprises a housing 51, a plug 52 connectable to the socket for cigarette lighter of the vehicle, a receiver circuit 53 mounted inside the housing 51 to receive the necessary working voltage from the car battery power supply and adapted to receive the radio alarm signal from the control IC board 292, and an alarm circuit 54 electrically connected to the receiver circuit 53. The alarm circuit 54 comprises a face panel 541 mounted on the outer wall of the housing 51, and an indicator light 540 installed in the face panel 541 and controlled by the radio alarm signal from the control IC board 292 through receiver circuit 53 to give off light.

According to the present invention, one receiver and alarm unit 50 can be used with four tire pressure detectors 20. In this case, the four tire pressure detectors 20 are respectively installed in the four wheels of the vehicle, and the receiver and alarm unit 50 has four indicator lights 540 corresponding to the four tire pressure detectors 20. Preferably, LEDs are used for the indictor lights 540.

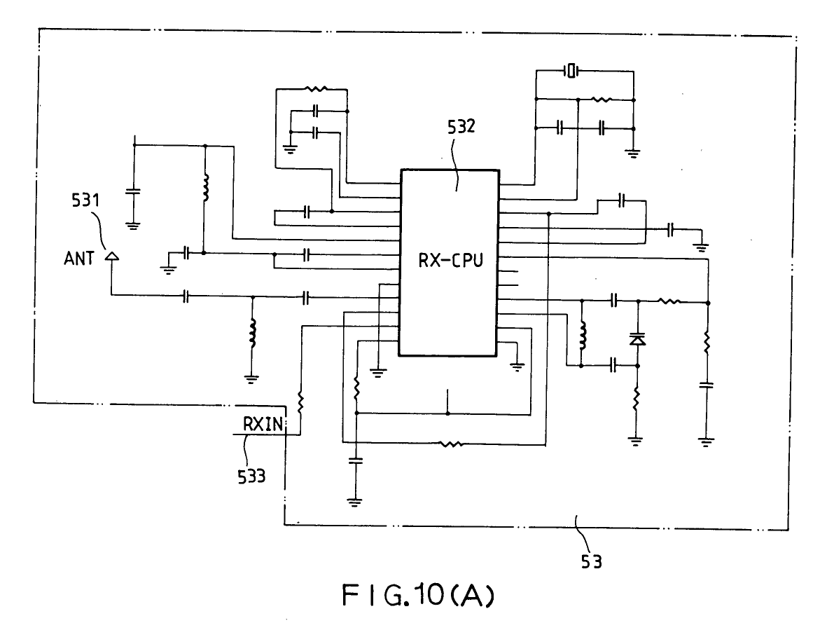

Referring to FIG. 9, the control IC board 292 comprises a radio transmitter circuit formed of a transmitting antenna 294, a TX-IC 295, a CPU 296, and related electronic component parts. Because the control IC board is of the known art and its composition is not within the scope of the claims of the present invention, no further detailed description in this regard is necessary. The operation of the control IC board 292 is controlled through a control switch SW. The aforesaid metal conductor 252 and the metal probe 24 form the control switch SW. When tire pressure low, the flexible air pressure chamber 25 is automatically forced upwards by the negative pole metal spring member 26 force the metal conductor member 252 into contact with the metal probe 24 to further close the circuit, and therefore the battery cell 28 and the control IC board 292 are electrically connected to provide the radio alarm signal.

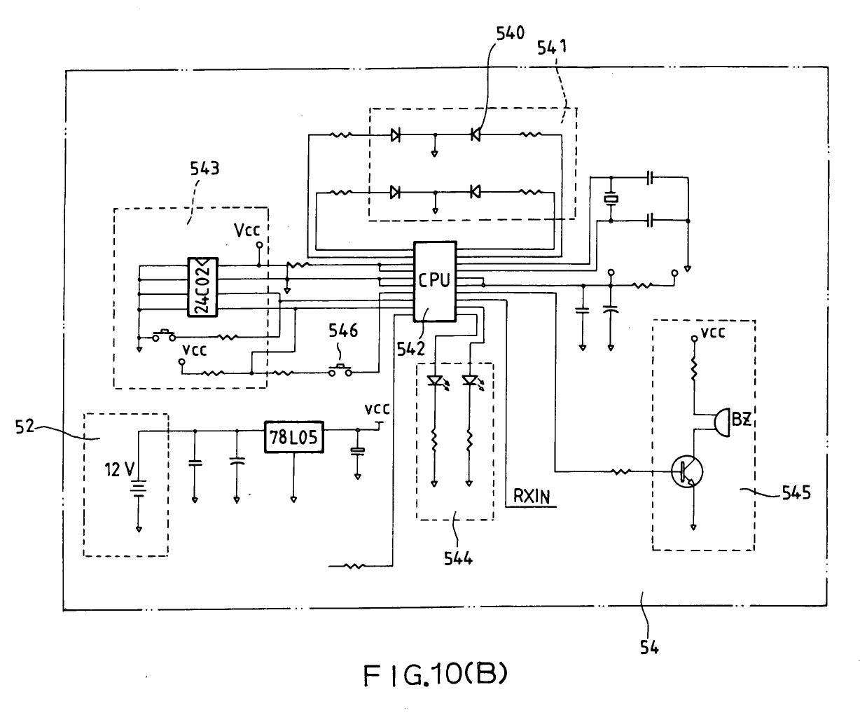

Referring to FIG. 10A, the receiver circuit 53 of the receiver and alarm unit 50 comprises a receiving antenna 531, a RX-CPU 532, and related electronic component parts. After receipt of the radio alarm signal from the control IC board 292 by the receiving antenna 531, the signal is processed through the RX-CPU 532 and then sent to the alarm circuit 54 through a connection line 533.

Referring to FIG. 10B, the alarm circuit 54 comprises the aforesaid face panel 541, a CPU 542, a memory circuit 543, a power indicator circuit 544, an alarm activation circuit 545, and a reset 546. The housing 51 and the plug 52 are fastened together to hold the receiver circuit 53 and the alarm circuit 54. The face panel 541 is provided at the outer wall of the housing 51 to hold the indicator light(s) 540 on the outside. Alternatively, a LCD panel may be used to substitute for the combination of the face panel 541 and the indicator light(s) 540.

As indicated above, the invention uses a tire pressure detector 20, a locking device 30, and a receiver and alarm unit 50 to form the desired tire pressure detector and alarm system. The tire pressure detector 20 is highly reliable and durable and does not produce a false signal during high speed rotation. The arrangement of the electrically insulative cap 22, the metal spring plate 23, the metal probe 24 and the flexible air pressure chamber 25 form an open circuit when the air pressure of the tire is within the normal range. The circuit is kept off after disconnection of the tire pressure detector 20 from the air valve 40. The locking device 30 locks the tire pressure detector 20 to the air valve 40, preventing disconnection of the tire pressure detector 20 from the air valve 40 by an external force. Further, the receiver and alarm unit 50 can directly be connected to the socket for cigarette lighter of the vehicle to obtain the necessary working voltage of the car battery power supply.

A prototype of tire pressure detector and alarm system has been constructed with the features of FIGS. 3˜10. The tire pressure detector and alarm system functions smoothly to provide all of the features discussed earlier.

Although a particular embodiment of the present invention has been shown and described, it will be understood that various modifications and changes could be made thereunto without departing from the spirit and scope of the invention disclosed.

What is claimed is:

1. A tire pressure detector and alarm system comprising:
a) a tire pressure detector adapted to detect the tire pressure of a vehicle wheel and to provide an alarm signal when the tire pressure of the vehicle wheel is low, said tire pressure detector comprising:
a first metal casing, said first metal casing comprising a front neck connectable to the air valve of a motor vehicle, a first outer thread extending around the periphery of said front neck, a second outer thread extending around of the periphery of a body thereof, and a first O-ring mounted inside said front neck;
an electrically insulative cap mounted inside said first metal casing and defining therein a first receiving chamber and a second receiving chamber;
a metal probe axially forwardly extending from the center of a front side of said electrically insulative cap and having an air through hole extending from the periphery to a bottom end thereof in air communication with said first receiving chamber;
a metal spring plate mounted on said metal probe inside said first metal casing and stopped between said first O-ring and said electrically insulative cap, said metal spring plate having a center through hole for the passing of said metal probe;
a flexible air pressure chamber formed of an electrically insulative flexible diaphragm and a metal conductor member, said electrically insulative flexible diaphragm being inserted into said first receiving chamber of said electrically insulative cap, said metal conductor member being mounted in said electrically insulative flexible diaphragm and stopped at a bottom end of said metal probe;
a negative pole metal spring member provided at a bottom side of said metal conductor member;
a metal holder member mounted in said first receiving chamber of said electrically insulative cap, said metal holder member having a front receptacle, which accommodates said negative pole metal spring member and has a front edge pressed on the periphery of said electrically insulative flexible diaphragm to keep said first receiving chamber in an airtight status;
a battery cell mounted in said second receiving chamber of said electrically insulative cap, having a positive terminal maintained in contact with said metal holder member and a positive terminal;
a second metal casing, said second metal casing having an inner thread threaded onto the second outer thread of said first metal casing;
a control IC board mounted inside said second metal casing and kept in contact with said first metal casing and adapted to provide a radio alarm signal when the air pressure of the vehicle wheel in which said tire pressure detector is installed in low; and
a positive pole metal spring member installed in said control IC board and stopped against the negative terminal of said battery cell;
b) a locking device mounted on the air valve of a vehicle wheel and adapted to lock said tire pressure detector, said locking device comprising a locknut mounted on the air valve of a vehicle wheel and threaded onto the first outer thread of said first metal casing and a top shoulder above the inner thread, and a packing plate threaded onto the air valve of the motor vehicle in which said locknut is installed and mounted inside said locknut and stopped between the inner thread and top shoulder of said locknut; and
c) a receiver and alarm unit adapted to receive radio alarm signal from said tire pressure detector, said receiver and alarm unit comprising a housing, a plug fixedly provided at one side of said housing and connectable to the socket for cigarette lighter of a motor vehicle, a receiver circuit mounted inside said housing and adapted to obtain the necessary working voltage from the car battery power supply of the motor vehicle in which said plug is installed and to receive the radio alarm signal from said from the control IC board, and an alarm circuit electrically connected to said receiver circuit and adapted to display said radio alarm signal, said alarm circuit comprising a display panel provided outside said housing for indicating said radio alarm signal.

2. The tire pressure detector and alarm system as claimed in claim 1, wherein said electrically insulative flexible diaphragm is made of rubber.

3. The tire pressure detector and alarm system as claimed in claim 1, wherein said first metal casing further has a second O-ring mounted on the second outer thread thereof.

4. The tire pressure detector and alarm system as claimed in claim 1, wherein said display panel is a LED (light emitting diode) display panel.

5. The tire pressure detector and alarm system as claimed in claim 1, wherein said display panel is a LCD (liquid crystal display) panel.
